(19) United States
(12) Patent Application Publication
(10) Pub. No.: US 2008/0308475 A1
(43) Pub. Date: Dec. 18, 2008

(54) Demineralizer

(75) Inventors: Yoshiaki Ito, Nagasaki-ken (JP); Kazuhisa Takeuchi, Nagasaki-ken (JP); Hideo Iwahashi, Nagasaki-ken (JP); Masahiro Kishi, Hyogo-ken (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MITSUBISHI HEAVY INDUSTRIES, LTD., Tokyo (JP)

(21) Appl. No.: 12/149,175

(22) Filed: Apr. 28, 2008

(30) Foreign Application Priority Data
Jun. 15, 2007 (JP) 2007-159119

(51) Int. Cl. B01D 21/34; C02F 1/44; B01D 63/00

(52) U.S. Cl. 210/149; 210/321.72

(57) ABSTRACT

The present invention provides a demineralizer capable of leveling out product water quantity and product water quality through the year regardless of raw water temperature, cutting down running costs, and improving the rate of operation. The demineralizer includes: a second reverse osmosis membrane module for separating primary concentrated water into secondary product water and secondary concentrated water; a product water supply pipe for guiding primary product water to a product water tank located downstream thereof; a secondary product water supply pipe for guiding the secondary product water downstream; a return pipe whose one end is connected to one end of the secondary product water supply pipe, and whose other end is connected to a raw water supply pipe; a by-pass pipe whose one end is connected to said one end of the secondary product water supply pipe, and whose other end is connected to the product water supply pipe; and a valve connected at some point in the return pipe and/or the by-pass pipe.

### BACKGROUND OF THE INVENTION

1. Field of the Invention

The present invention relates to a demineralizer for desalinating raw water such as seawater, groundwater containing a large amount of salt or brine water.

This application is based on Japanese Patent Application No. 2007-159119, the content of which is incorporated herein by reference.

2. Description of Related Art

As a demineralizer for desalinating raw water such as seawater or very saline groundwater and salt water, for example, one disclosed in Japanese Unexamined Patent Application, Publication No. 6-114372 is known.

However, a reverse osmosis membrane used in such a demineralizer has properties that largely depend on the temperature of raw water (such as seawater or very saline groundwater and salt water). More specifically, if raw water is seawater, for example, the reverse osmosis membrane has the following properties. In the summer season during which the raw water temperature is high, product water quantity is increased while product water quality is decreased (i.e., the demineralization performance is degraded). On the other hand, in the winter season during which the raw water temperature is low, product water quantity is reduced while product water quality is improved (i.e., the demineralization performance is enhanced). Therefore, in the demineralizer using the reverse osmosis membrane, there has been a problem that product water quantity and product water quality cannot be maintained constant through the year.

To cope with such a problem, in recent years, in order to reduce product water quantity and improve product water quality in the summer season during which the raw water temperature is high, the following measures have been taken: some of a large number of communication holes passing through reverse osmosis membranes are closed with plugs to reduce the number of operational reverse osmosis membranes in operating a demineralizer.

However, in these measures, there has been a problem that when some of the communication holes are closed with plugs, and when these plugs are removed, the operation of the demineralizer has to be temporarily stopped to conduct work, thus reducing the rate of operation of the demineralizer.

Furthermore, there has also been a problem that the reverse osmosis membrane to be closed with plugs must be stored so as to be immersed in a storage solution (preservative solution), and the work for filling the membrane with the storage solution is additionally required, thus unfavorably increasing running costs.

### BRIEF SUMMARY OF THE INVENTION

The present invention has been made in view of the above-described circumstances, and its object is to provide a demineralizer capable of leveling out product water quantity and product water quality through the year regardless of the temperature of raw water, cutting down running costs, and improving the rate of operation.

To solve the above-described problems, the present invention adopts the following means.

A demineralizer according to a first aspect of the present invention includes: a high-pressure pump for raising the pressure of raw water guided via a raw water supply pipe, and for delivering the raw water downstream; a first reverse osmosis membrane module, located downstream of the high-pressure pump, for separating the raw water into primary product water and primary concentrated water; a second reverse osmosis membrane module, located downstream of the first reverse osmosis membrane module, for separating the primary concentrated water into secondary product water and secondary concentrated water; a product water supply pipe for guiding the primary product water to a product water tank located downstream thereof; a secondary product water supply pipe for guiding the secondary product water downstream; a return pipe whose one end is connected to one end of the secondary product water supply pipe, and whose other end is connected to the raw water supply pipe; a by-pass pipe whose one end is connected to said one end of the secondary product water supply pipe, and whose other end is connected to the product water supply pipe; and a valve connected at some point in the return pipe and/or the by-pass pipe.

In the demineralizer according to the first aspect, by only adjusting (manipulating) the opening of the valve, the following operations are enabled. For example, in the summer season during which the raw water temperature is high, as shown in FIG. 1, the percentage of the secondary product water, guided to the suction side of the high-pressure pump via the return pipe, is increased, thereby making it possible to reduce the percentage of the secondary product water guided to the product water tank. On the other hand, in the winter season during which the raw water temperature is low, as shown in FIG. 2, the percentage of the secondary product water, guided to the product water supply pipe via the by-pass pipe, is increased, thereby making it possible to increase the percentage of the secondary product water guided to the product water tank.

That is, if the product water quantity is increased and the product water quality is decreased (i.e., the demineralization performance is degraded), the valve is adjusted (manipulated) in the opening direction to increase the percentage of the secondary product water guided to the suction side of the high-pressure pump via the return pipe, thereby reducing the product water quantity. Then, together with the supply water passing through the raw water supply pipe, the secondary product water, guided to the suction side of the high-pressure pump via the return pipe, is supplied to the first reverse osmosis membrane module again by the high-pressure pump. After having salt and other impurities further removed by this first reverse osmosis membrane module, the secondary product water is guided to the product water tank via the product water supply pipe, thus improving the product water quality.

On the other hand, if the product water quantity is reduced and the product water quality is improved (i.e., the demineralization performance is enhanced), the valve is adjusted (manipulated) in the closing direction to increase the percentage of the secondary product water guided to the product water supply pipe via the by-pass pipe, thus increasing the product water quantity.

As described above, in the demineralizer according to the first aspect, by only adjusting (manipulating) the opening of the valve, it is possible to level out the product water quantity and product water quality through the year regardless of the raw water temperature.

Thus, for example, it is possible to eliminate the need for the works (i.e., the plug attaching work, plug removing work, storage solution filling work, and storage solution discharging work) that have been conventionally required to level out the product water quantity and product water quality in the summer and winter seasons, between which the raw water temperature is greatly changed; therefore, it is possible to cut down running costs.

Further, since the need for the above-mentioned works can be eliminated, the number of times the demineralizer is started and the number of times the demineralizer is stopped can each be reduced, thus making it possible to reduce the risk such as the damage and/or breakage of the reverse osmosis membrane element associated with the start and stop of the demineralizer, and to improve the rate of operation of the demineralizer.

Moreover, even if the raw water temperature is greatly changed regardless of the season, weather, or the like (for example, even if the raw water temperature is increased due to the oncoming typhoon), it is possible to circumstantially and immediately cope with the temperature change and to improve the reliability of the demineralizer by only adjusting (manipulating) the opening of the valve while watching the raw water temperature.

The demineralizer according to the first aspect is more preferably configured to allow the opening of the valve to be automatically adjusted in accordance with the temperature of the raw water so that the quantity and quality of the product water sent to the product water tank are maintained approximately constant.

In such a demineralizer, it is unnecessary to adjust (manipulate) the opening of the valve in accordance with the raw water temperature, thereby making it possible to fully automatically level out the product water quantity and product water quality through the year regardless of the raw water temperature.

A demineralizer according to a second aspect of the present invention includes: a high-pressure pump for raising the pressure of raw water guided via a raw water supply pipe, and for delivering the raw water downstream; a first reverse osmosis membrane module, located downstream of the high-pressure pump, for separating the raw water into primary product water and primary concentrated water; a second reverse osmosis membrane module, located downstream of the first reverse osmosis membrane module, for separating the primary concentrated water into secondary product water and secondary concentrated water; a product water supply pipe for guiding the primary product water to a product water tank located downstream thereof; a secondary product water supply pipe for guiding the secondary product water downstream; a return pipe whose one end is connected to one end of the secondary product water supply pipe, and whose other end is connected to the raw water supply pipe; a by-pass pipe whose one end is connected to said one end of the secondary product water supply pipe, and whose other end is connected to the product water supply pipe; a drain pipe for guiding the secondary concentrated water to the outside of the system; a first valve connected at some point in the return pipe; a second valve connected to a part of the raw water supply pipe, which is located between the high-pressure pump and the first reverse osmosis membrane module; a third valve connected at some point in the drain pipe; a fourth valve connected to the product water supply pipe; and a fifth valve connected at some point in the by-pass pipe.

In the demineralizer according to the second aspect, by only adjusting (manipulating) the openings of the first, the second, the third, the fourth and the fifth valves, the following operations are enabled. For example, in the summer season during which the raw water temperature is high, the percentage of the secondary product water, guided to the suction side of the high-pressure pump via the return pipe, is increased, thereby making it possible to reduce the percentage of the secondary product water guided to the product water tank. On the other hand, in the winter season during which the raw water temperature is low, the percentage of the secondary product water, guided to the product water supply pipe via the by-pass pipe, is increased, thereby making it possible to increase the percentage of the secondary product water guided to the product water tank.

That is, if the product water quantity is increased and the product water quality is decreased (i.e., the demineralization performance is degraded), each valve is adjusted (manipulated) to increase the percentage of the secondary product water guided to the suction side of the high-pressure pump via the return pipe, thereby reducing the product water quantity. Then, together with the supply water passing through the raw water supply pipe, the secondary product water, guided to the suction side of the high-pressure pump via the return pipe, is supplied to the first reverse osmosis membrane module again by the high-pressure pump. After having salt and other impurities further removed by this first reverse osmosis membrane module, the secondary product water is guided to the product water tank via the product water supply pipe, thus improving the product water quality.

On the other hand, if the product water quantity is reduced and the product water quality is improved (i.e., the demineralization performance is enhanced), each valve is adjusted (manipulated) to increase the percentage of the secondary product water guided to the product water supply pipe via the by-pass pipe, thus increasing the product water quantity.

As described above, in the demineralizer according to the second aspect, by only adjusting (manipulating) the opening of each valve, it is possible to level out the product water quantity and product water quality through the year regardless of the raw water temperature.

Thus, for example, it is possible to eliminate the need for the works (i.e., the plug attaching work, plug removing work, storage solution filling work, and storage solution discharging work) that have been conventionally required to level out the product water quantity and product water quality in the summer and winter seasons, between which the raw water temperature is greatly changed; therefore, it is possible to cut down running costs.

Further, since the need for the above-mentioned works can be eliminated, the number of times the demineralizer is started and the number of times the demineralizer is stopped can each be reduced, thus making it possible to reduce the risk such as the damage and/or breakage of the reverse osmosis membrane element associated with the start and stop of the demineralizer, and to improve the rate of operation of the demineralizer.

Moreover, even if the raw water temperature is greatly changed regardless of the season, weather, or the like (for example, even if the raw water temperature is increased due to the oncoming typhoon), it is possible to circumstantially and immediately cope with the temperature change and to improve the reliability of the demineralizer by only adjusting (manipulating) the opening of each valve while watching the raw water temperature.

The demineralizer according to the second aspect is more preferably configured to allow each of the openings of the first, the second, the third, the fourth and the fifth valves to be automatically adjusted in accordance with the temperature of the raw water so that the quantity and quality of the product water sent to the product water tank are maintained approximately constant.

In such a demineralizer, it is unnecessary to adjust (manipulate) the opening of each valve in accordance with the raw water temperature, thereby making it possible to fully automatically level out the product water quantity and product water quality through the year regardless of the raw water temperature.

Consequently, the present invention has the effects of being able to level out the product water quantity and product water quality through the year regardless of the raw water temperature, to cut down running costs, and to improve the rate of operation.

### BRIEF DESCRIPTION OF THE SEVERAL VIEWS OF THE DRAWINGS

FIG. 1 is a schematic block diagram of the principal components of a desalination apparatus according to a first embodiment of the present invention, showing the flow of water when the temperature of raw water is high.

FIG. 2 is a schematic block diagram of the principal components of the desalination apparatus according to the first embodiment of the present invention, showing the flow of water when the temperature of raw water is low.

FIG. 3 is a schematic block diagram of the principal components of a desalination apparatus according to a second embodiment of the present invention.

FIG. 4 is a table showing calculation (simulation) results obtained when product water is produced using the desalination apparatus shown in FIG. 3.

FIG. 5 is a graph showing the relationship between the temperature and the circulation flow rate in FIG. 4.

FIG. 6 is a graph showing the relationship between the temperature, and the Cl⁻ concentration in product water and TDS concentration in product water in FIG. 4.

FIG. 7 is a graph showing the relationship between the temperature, and the necessary pump flow rate and necessary pump pressure in FIG. 4.

FIG. 8 is a graph showing the relationship between the necessary pump flow rate and the necessary pump pressure in FIG. 4.

### DETAILED DESCRIPTION OF THE INVENTION

### First Embodiment

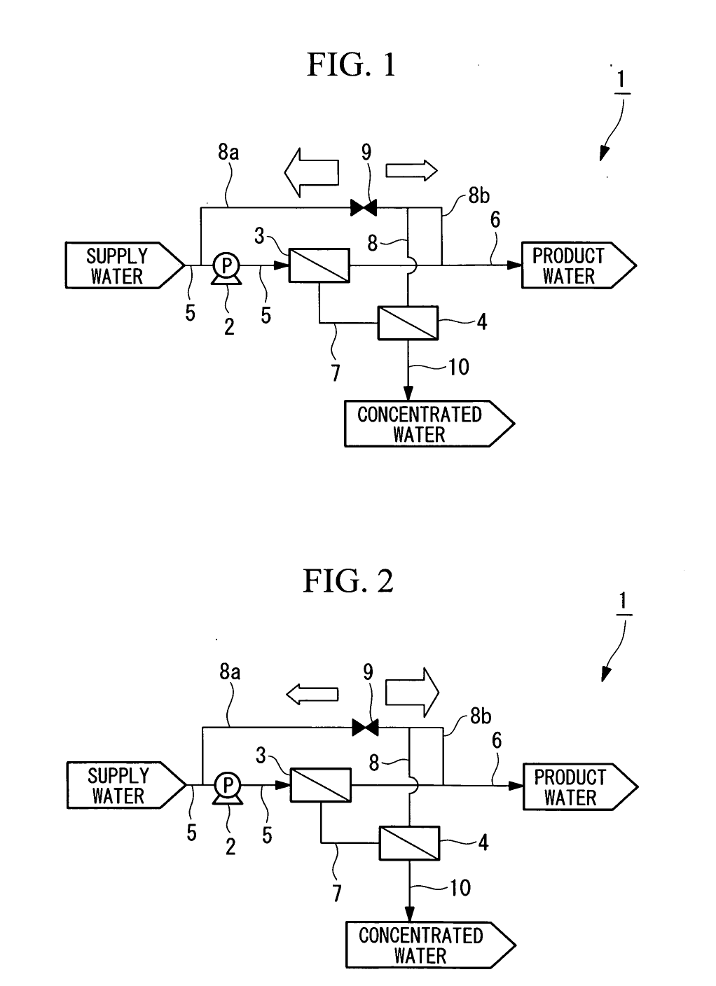

Hereinafter, a first embodiment of a demineralizer according to the present invention will be described with reference to FIGS. 1 and 2.

FIG. 1 is a schematic block diagram of the principal components of the demineralizer according to the present embodiment, showing the flow of water when the temperature of raw water is high, and FIG. 2 is a schematic block diagram of the principal components of the demineralizer according to the present embodiment similarly to FIG. 1, showing the flow of water when the temperature of raw water is low.

As shown in FIGS. 1 and 2, the demineralizer (hereinafter called a “desalination apparatus”) 1 according to the present embodiment includes: a high-pressure pump 2; a first reverse osmosis membrane module (hereinafter called a “first RO membrane module”) 3; and a second reverse osmosis membrane module (hereinafter called a “second RO membrane module”) 4.

Upstream of the high-pressure pump 2, there are located: a raw water pump (not shown) for pumping up raw water (such as seawater or very saline groundwater and salt water) at a predetermined (constant) flow rate; and a strainer, located between this raw water pump and the high-pressure pump 2, for removing large insoluble matter in raw water. Further, between the raw water pump and the strainer, for example, there are located: a chlorine agent supply device (not shown) for supplying a chlorine agent to raw water to suppress activities of microorganisms; and/or a pretreatment device such as an acid supply device (not shown) for supplying acid to raw water to adjust the pH thereof. Furthermore, raw water (hereinafter called “supply water”), which has passed through the strainer, is guided to the high-pressure pump 2 via a raw water supply pipe 5.

The high-pressure pump 2 is, for example, a volute pump for raising the pressure of the supply water guided from the strainer via the raw water supply pipe 5 located upstream of the pump. The supply water, the pressure of which has been raised by the high-pressure pump 2, is guided to the first RO membrane module 3 via a part of the raw water supply pipe 5, which is located downstream of the high-pressure pump 2.

The first RO membrane module 3 includes a reverse osmosis membrane element (not shown) inside a pressure-proof vessel (not shown), and separates the supply water, supplied from the high-pressure pump 2, into fresh water, and concentrated water containing large amounts of salt and other impurities.

The reverse osmosis membrane element, for example, includes: a core pipe having a plurality of holes at its outer peripheral surface; and a spiral membrane consisting of aromatic polyamide wound (attached) around the outer peripheral surface of this core pipe.

Furthermore, the supply water supplied from the high-pressure pump 2 is circulated through a gap, located between the inner peripheral surface of the pressure-proof vessel and the outer peripheral surface of the spiral membrane, toward the inner peripheral surface side of the spiral membrane (i.e., the outer peripheral surface side of the core pipe).

Permeated water demineralized by the first RO membrane module 3, i.e., permeated water permeated through the spiral membrane of the reverse osmosis membrane element (which will be hereinafter called “primary product water”), is guided to a first permeated water supply pipe (hereinafter called a “product water supply pipe”) 6 via a primary product water delivery port (not shown) provided at the first RO membrane module 3.

Furthermore, downstream of the product water supply pipe 6, there are connected: a product water tank (not shown) for briefly (temporarily) storing product water; and a product water pump for delivering, when necessary, the product water stored in this product water tank.

On the other hand, the supply water that has reached the holes of the core pipe without permeating through the spiral membrane of the reverse osmosis membrane element, i.e., the supply water that has reached the holes of the core pipe without penetrating into the inner portion of the spiral membrane (which will be hereinafter called “primary concentrated water”), is guided to a concentrated water supply pipe 7 via a first concentrated water delivery port (not shown) provided at the first RO membrane module 3.

Further, downstream of the concentrated water supply pipe 7, the second RO membrane module 4 is connected.

The second RO membrane module 4 includes a reverse osmosis membrane element (not shown) inside a pressure-proof vessel (not shown), and separates the primary concentrated water, supplied from the first RO membrane module 3, into fresh water, and concentrated water containing large amounts of salt and other impurities.

The reverse osmosis membrane element, for example, includes: a core pipe having a plurality of holes at its outer peripheral surface; and a spiral membrane consisting of aromatic polyamide wound (attached) around the outer peripheral surface of this core pipe.

Furthermore, the primary concentrated water supplied from the first RO membrane module 3 is circulated through a gap, located between the inner peripheral surface of the pressure-proof vessel and the outer peripheral surface of the spiral membrane, toward the inner peripheral surface side of the spiral membrane (i.e., the outer peripheral surface side of the core pipe).

Permeated water demineralized by the second RO membrane module 4, i.e., permeated water permeated through the spiral membrane of the reverse osmosis membrane element (which will be hereinafter called “secondary product water”), is guided to a second permeated water, supply pipe (hereinafter called a “secondary product water supply pipe”) 8 via a secondary product water delivery port (not shown) provided at the second RO membrane module 4.

Further, a downstream end of the secondary product water supply pipe 8 is connected to an upstream end of a return pipe 8a and an upstream end of a by-pass pipe 8b.

At some point in the return pipe 8a, a manual valve 9 serving as a manual on-off valve is connected, and a downstream end of the return pipe 8a is connected to a part of the raw water supply pipe 5, which is located between the strainer and the high-pressure pump 2.

On the other hand, a downstream end of the by-pass pipe 8b is connected to a part of the product water supply pipe 6 located between the first RO membrane module 3 and the product water tank.

Furthermore, when the manual valve 9 is fully closed, the secondary product water, guided from the secondary product water delivery port of the second RO membrane module 4 to the secondary product water supply pipe 8, is guided to the product water supply pipe 6 through the by-pass pipe 8b. Then, together with the primary product water passing through the product water supply pipe 6, the secondary product water becomes product water to flow downstream, and will be stored in the product water tank.

On the other hand, when the manual valve 9 is fully opened, (approximately) the entire quantity of the secondary product water, guided from the secondary product water delivery port of the second RO membrane module 4 to the secondary product water supply pipe 8, is guided to the raw water supply pipe 5 through the return pipe 8a. Then, together with the supply water passing through the raw water supply pipe 5, the secondary product water will be supplied to the first RO membrane module 3 by the high-pressure pump 2.

In other words, the ratio between the flow rate of the secondary product water passing through the return pipe 8a and that of the secondary product water passing through the by-pass pipe 8b can be changed by appropriately adjusting the opening of the manual valve 9.

On the other hand, the primary concentrated water that has reached the holes of the core pipe without permeating through the spiral membrane of the reverse osmosis membrane element, i.e., the primary concentrated water that has reached the holes of the core pipe without penetrating into the inner portion of the spiral membrane, is guided to a drain pipe 10 via a secondary concentrated water delivery port (not shown) provided at the second RO membrane module 4. Then, the primary concentrated water becomes secondary concentrated water, which will be discharged to the outside of the system (i.e., the outside of the desalination apparatus 1).

In the desalination apparatus 1 according to the present embodiment, by only adjusting (manipulating) the opening of the manual valve 9, the following operations are enabled. For example, in the summer season during which the raw water temperature is high, as shown in FIG. 1, the percentage of the secondary product water, guided to the suction side of the high-pressure pump 2 via the return pipe 8a, is increased, thereby making it possible to reduce the percentage of the secondary product water guided to the product water tank. On the other hand, in the winter season during which the raw water temperature is low, as shown in FIG. 2, the percentage of the secondary product water, guided to the product water supply pipe 6 via the by-pass pipe 8b, is increased, thereby making it possible to increase the percentage of the secondary product water guided to the product water tank.

That is, if the product water quantity is increased and the product water quality is decreased (i.e., the demineralization performance is degraded), the manual valve 9 is adjusted (manipulated) in the opening direction to increase the percentage of the secondary product water guided to the suction side of the high-pressure pump 2 via the return pipe 8a, thereby reducing the product water quantity. Then, together with the supply water passing through the raw water supply pipe 5, the secondary product water, guided to the suction side of the high-pressure pump 2 via the return pipe 8a, is supplied to the first RO membrane module 3 again by the high-pressure pump 2. After having salt and other impurities further removed by the first RO membrane module 3, the secondary product water is guided to the product water tank via the product water supply pipe 6, thus improving the product water quality.

On the other hand, if the product water quantity is reduced and the product water quality is improved (i.e., the demineralization performance is enhanced), the manual valve 9 is adjusted (manipulated) in the closing direction to increase the percentage of the secondary product water guided to the product water supply pipe 6 via the by-pass pipe 8b, thus increasing the product water quantity.

As described above, in the desalination apparatus 1 according to the present embodiment, by only adjusting (manipulating) the opening of the manual valve 9, it is possible to level out the product water quantity and product water quality through the year regardless of the raw water temperature.

Thus, for example, it is possible to eliminate the need for the works (i.e., the plug attaching work, plug removing work, storage solution filling work, and storage solution discharging work) that have been conventionally required to level out the product water quantity and product water quality in the summer and winter seasons, between which the raw water temperature is greatly changed; therefore, it is possible to cut down running costs.

Further, since the need for the above-mentioned works can be eliminated, the number of times the desalination apparatus 1 is started and the number of times the desalination apparatus 1 is stopped can each be reduced, thus making it possible to reduce the risk such as the damage and/or breakage of the reverse osmosis membrane element (more specifically, the spiral membrane) associated with the start and stop of the desalination apparatus 1, and to improve the rate of operation of the desalination apparatus 1.

Moreover, even if the raw water temperature is greatly changed regardless of the season, weather, or the like (for example, even if the raw water temperature is increased due to the oncoming typhoon), it is possible to circumstantially and immediately cope with the temperature change and to improve the reliability of the desalination apparatus 1 by only adjusting (manipulating) the opening of the manual valve 9 while watching the raw water temperature.

### Second Embodiment

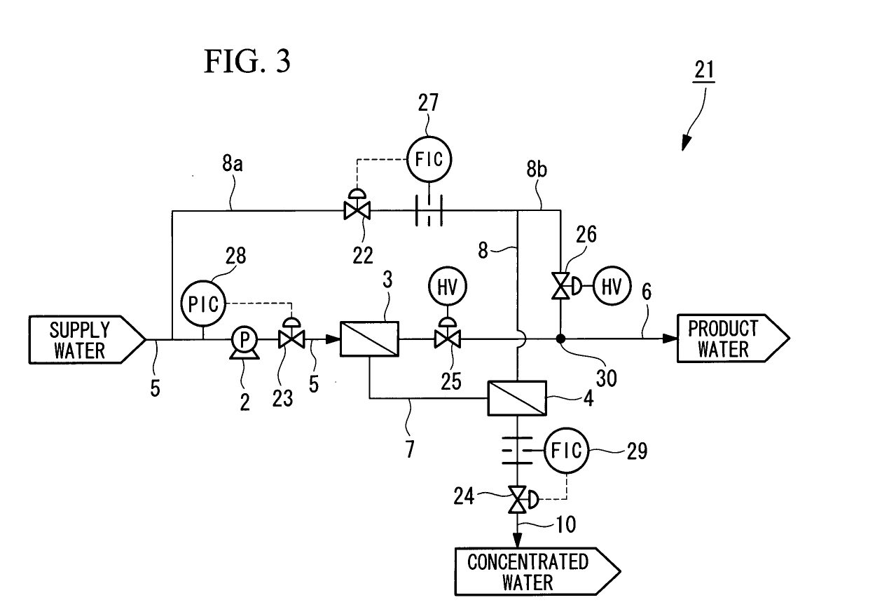

A second embodiment of a desalination apparatus according to the present invention will be described with reference to FIG. 3. FIG. 3 is a schematic block diagram of the principal components of the desalination apparatus according to the present embodiment.

The desalination apparatus 21 according to the present embodiment differs from the desalination apparatus 1 according to the above-described first embodiment in that automatic valves 22, 23 and 24 and manual valves 25 and 26 are provided instead of the manual valve 9. The other components are similar to those in the above-described first embodiment, and therefore, the description of those components will be omitted.

It should be noted that the same members are identified with the same reference numerals as in the above-described first embodiment.

As shown in FIG. 3, at some point in the return pipe 8a, the automatic valve (first valve) 22 serving as an automatic on-off valve is connected, and a flowmeter (first flowmeter) 27 is attached to a part of the return pipe 8a, which is located upstream of this automatic valve 22. In addition, this automatic valve 22 is formed so that the opening thereof is adjusted (manipulated) based on a measurement result obtained by the flowmeter 27.

Furthermore, at some point in the raw water supply pipe 5, which is located downstream of the high-pressure pump 2, the automatic valve (second valve) 23 serving as an automatic on-off valve is connected, and a pressure gauge 28 is attached to some point in the raw water supply pipe 5, which is located upstream of the high-pressure pump 2. In addition, this automatic valve 23 is formed so that the opening thereof is adjusted (manipulated) based on a measurement result obtained by the pressure gauge 28.

Moreover, at some point in the drain pipe 10, the automatic valve (third valve) 24 serving as an automatic on-off valve is connected, and a flowmeter (second flowmeter) 29 is attached to a part of the drain pipe 10, which is located upstream of this automatic valve 24. In addition, this automatic valve 24 is formed so that the opening thereof is adjusted (manipulated) based on a measurement result obtained by the flowmeter 29.

On the other hand, a part of the product water supply pipe 6, located upstream of a merging section 30 to which the downstream end of the by-pass pipe 8b is connected, is connected with the manual valve (fourth valve) 25 serving as a manual on-off valve.

Further, at some point in the by-pass pipe 8b, the manual valve (fifth valve) 26 serving as a manual on-off valve is connected.

Furthermore, by adjusting (manipulating) the openings of these manual valves 25 and 26, it is possible to determine the ratio between the flow rate of the primary product water flowing from the first RO membrane module 3 into the product water tank through the product water supply pipe 6, and the flow rate of the secondary product water flowing out from the second RO membrane module 4 to the secondary product water supply pipe 8. In other words, these manual valves 25 and 26 are used to determine an approximate ratio between the distribution percentages of the permeated water from the two RO membrane modules 3 and 4.

In addition, by adjusting (manipulating) the opening of the automatic valve 22 based on the flow rate of the return pipe 8a, it is possible to adjust the flow rate of the circulation flow (which will be hereinafter called a “circulation flow rate”). The circulation flow is circulated as follows: the second RO membrane module 4→the secondary product water supply pipe 8→the return pipe 8a→the raw water supply pipe 5→the high-pressure pump 2→the raw water supply pipe 5→the first RO membrane module 3→the concentrated water supply pipe 7→the second RO membrane module 4.

It should be noted that in this operation (control), the circulation flow rate is specified (set). Specifically, when the raw water temperature is high, the circulation flow rate is increased, and when the raw water temperature is low, the circulation flow rate is reduced (for example, the circulation flow rate is set at 200 m³/h in the summer, and the circulation flow rate is set at 100 m³/h in the winter). Further, an operator adjusts, if necessary, this specified (set) circulation flow rate while watching the operational condition. Alternatively, the desalination apparatus 21 may be automatically operated using the set value of the circulation flow rate as a temperature function.

In the desalination apparatus 21 according to the present embodiment, by changing the specified value of the circulation flow rate in accordance with the raw water temperature, the product water quantity and product water quality can be approximately automatically leveled out through the year regardless of the raw water temperature.

Thus, for example, it is possible to eliminate the need for the works (i.e., the plug attaching work, plug removing work, storage solution filling work, and storage solution discharging work) that have been conventionally required to level out the product water quantity and product water quality in the summer and winter seasons, between which the raw water temperature is greatly changed; therefore, it is possible to cut down running costs.

Further, since the need for the above-mentioned works can be eliminated, the number of times the desalination apparatus 21 is started and the number of times the desalination apparatus 21 is stopped can each be reduced, thus making it possible to reduce the risk such as the damage and/or breakage of the reverse osmosis membrane element (more specifically, the spiral membrane) associated with the start and stop of the desalination apparatus 21, and to improve the rate of operation of the desalination apparatus 21.

Moreover, even if the raw water temperature is greatly changed regardless of the season, weather, or the like (for example, even if the raw water temperature is increased due to the oncoming typhoon), it is possible to circumstantially and immediately cope with the temperature change and to improve the reliability of the desalination apparatus 21 by only adjusting (manipulating) the openings of the manual valves 25 and 26 while watching the raw water temperature.

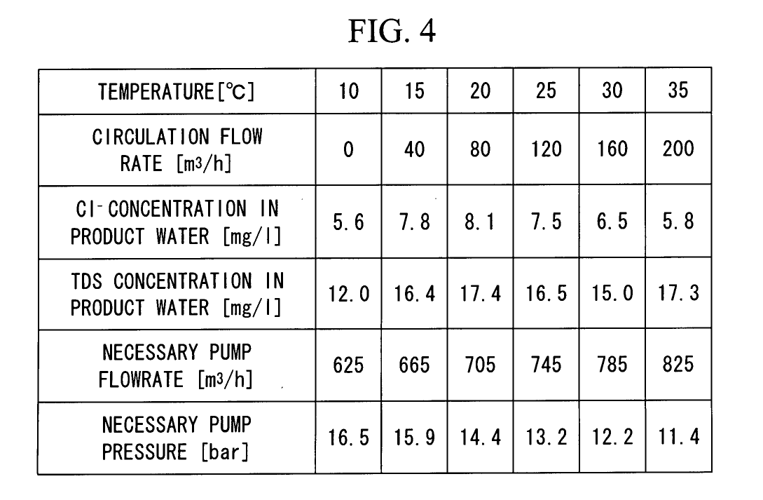

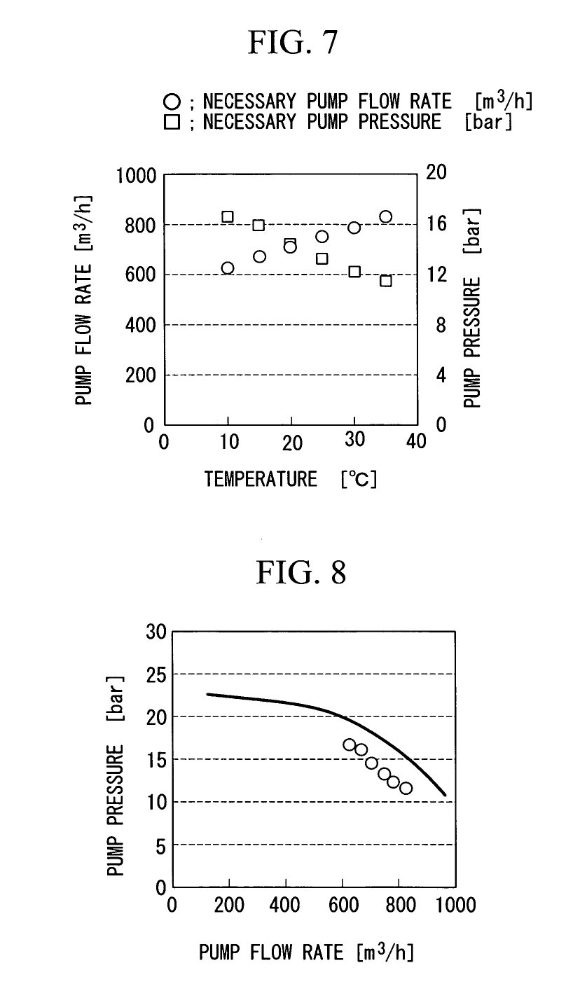

Next, calculation (simulation) results, obtained when an attempt is made to produce product water at a rate of about 563 m³ per hour using the desalination apparatus 21 according to the present embodiment, are shown in the table of FIG. 4 and in the graphs of FIGS. 5 to 7.

As shown in FIGS. 4 and 5, in the present calculation, the circulation flow rate is: 0 m³/h when the raw water temperature is at 10° C.; 40 m³/h when the raw water temperature is at 15° C.; 80 m³/h when the raw water temperature is at 20° C.; 120 m³/h when the raw water temperature is at 25° C.; 160 m³/h when the raw water temperature is at 30° C.; and 200 m³/h when the raw water temperature is at 35° C.

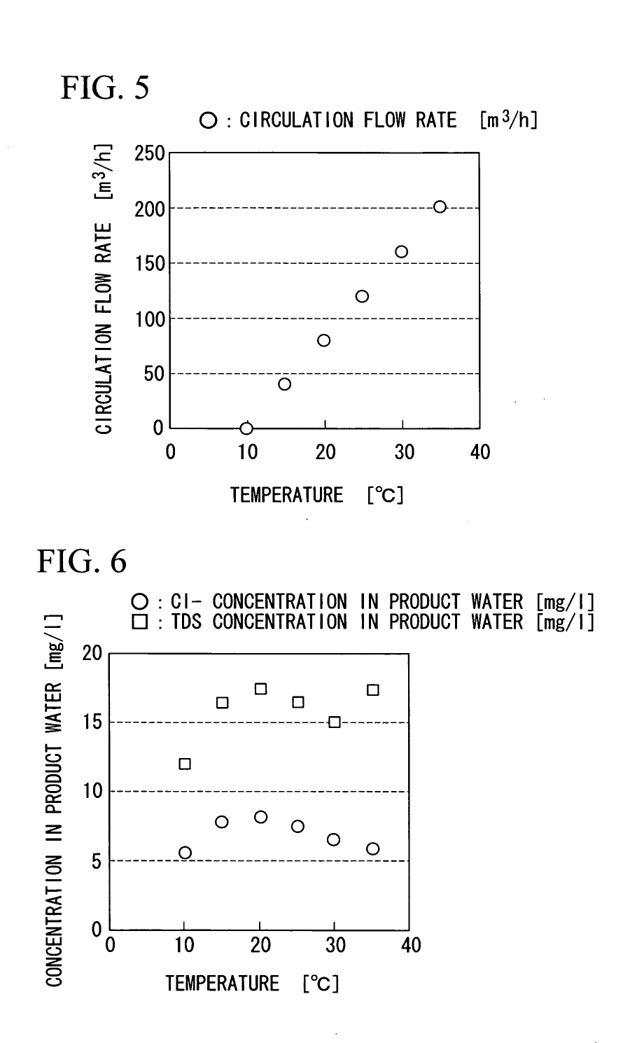

Furthermore, as can be seen (as is apparent) from FIGS. 4 and 6, the chlorine concentration (Cl⁻ concentration) in the product water and the dissolved salt concentration (TDS (Total Dissolved Solid) concentration) in the product water can each be maintained (kept) at approximately the same level regardless of the raw water temperature.

In other words, in the desalination apparatus 21 according to the present embodiment, by changing the specified value of the circulation flow rate in accordance with the raw water temperature, the product water quantity and product water quality can be maintained (kept) approximately constant regardless of the raw water temperature.

Further, the high-pressure pump 2 needs to have the characteristics as shown in FIGS. 4, 7 and 8; however, if the pump having the characteristics as indicated by the solid line in FIG. 8 is used, the energy loss caused by the automatic valve 23 can be reduced regardless of the raw water temperature. Specifically, even if the circulation flow rate is increased, the necessary pressure when the circulation flow rate is increased may be low, and therefore, the pump operable (usable) when there is no circulation flow rate (when the circulation flow rate is zero) can be used (as it is). In other words, the pump does not have to be increased in size, thus making it possible to avoid (prevent) the increase in equipment costs and running costs.

It should be noted that the present invention is not limited to the foregoing embodiments, but may be embodied in modified forms and varied forms without departing from the scope of the present invention. For example, the manual valve 9 described in the first embodiment may alternatively be provided at some point in the by-pass pipe 8b.

Furthermore, in the foregoing first embodiment, the manual valve 9 is provided at some point in the return pipe 8a in an attempt to cut down equipment costs. However, the present invention will not be limited to such an embodiment. Alternatively, instead of this manual valve 9, an automatic on-off valve, the opening of which is adjusted (manipulated) in accordance with the raw water temperature, may be provided.

Thus, it is unnecessary to adjust (manipulate) the opening of the manual valve 9 in accordance with the raw water temperature, thereby making it possible to fully automatically level out the product water quantity and product water quality through the year regardless of the raw water temperature.

Moreover, in the foregoing second embodiment, in an attempt to cut down equipment costs, the manual valve 25 is provided at a part of the product water supply pipe 6, located upstream of the merging section 30 to which the downstream end of the by-pass pipe 8b is connected, and the manual valve 26 is provided at some point in the by-pass pipe 8b. However, the present invention will not be limited to such an embodiment. Alternatively, instead of these manual valves 25 and 26, automatic on-off valves, the openings of which are adjusted (manipulated) in accordance with the temperature and/or quality of raw water, and secular changes in membrane performance, may be provided.

Thus, it is unnecessary to adjust (manipulate) the openings of the manual valves 25 and 26, thereby making it possible to fully automatically level out the product water quantity and product water quality.

What is claimed is:

1. A demineralizer comprising:
a high-pressure pump for raising the pressure of raw water guided via a raw water supply pipe, and for delivering the raw water downstream;
a first reverse osmosis membrane module, located downstream of the high-pressure pump, for separating the raw water into primary product water and primary concentrated water;
a second reverse osmosis membrane module, located downstream of the first reverse osmosis membrane module, for separating the primary concentrated water into secondary product water and secondary concentrated water;
a product water supply pipe for guiding the primary product water to a product water tank located downstream thereof;
a secondary product water supply pipe for guiding the secondary product water downstream;
a return pipe whose one end is connected to one end of the secondary product water supply pipe, and whose other end is connected to the raw water supply pipe;
a by-pass pipe whose one end is connected to said one end of the secondary product water supply pipe, and whose other end is connected to the product water supply pipe; and
a valve connected at some point in the return pipe and/or the by-pass pipe.

2. The demineralizer according to claim 1,
wherein the demineralizer is configured to allow the opening of the valve to be automatically adjusted in accordance with the temperature of the raw water so that the quantity and quality of the product water sent to the product water tank are maintained approximately constant.

3. A demineralizer comprising:
a high-pressure pump for raising the pressure of raw water guided via a raw water supply pipe, and for delivering the raw water downstream;
a first reverse osmosis membrane module, located downstream of the high-pressure pump, for separating the raw water into primary product water and primary concentrated water;
a second reverse osmosis membrane module, located downstream of the first reverse osmosis membrane module, for separating the primary concentrated water into secondary product water and secondary concentrated water;
a product water supply pipe for guiding the primary product water to a product water tank located downstream thereof;
a secondary product water supply pipe for guiding the secondary product water downstream;
a return pipe whose one end is connected to one end of the secondary product water supply pipe, and whose other end is connected to the raw water supply pipe;
a by-pass pipe whose one end is connected to said one end of the secondary product water supply pipe, and whose other end is connected to the product water supply pipe;
a drain pipe for guiding the secondary concentrated water to the outside of the system;
a first valve connected at some point in the return pipe;
a second valve connected to a part of the raw water supply pipe, which is located between the high-pressure pump and the first reverse osmosis membrane module;
a third valve connected at some point in the drain pipe;
a fourth valve connected to the product water supply pipe; and
a fifth valve connected at some point in the by-pass pipe.

4. The demineralizer according to claim 3,
wherein the demineralizer is configured to allow each of the openings of the first, the second, the third, the fourth and the fifth valves to be automatically adjusted in accordance with the temperature of the raw water so that the quantity and quality of the product water sent to the product water tank are maintained approximately constant.
